(19) United States
(12) Patent Application Publication
(10) Pub. No.: US 2013/0011547 A1
(43) Pub. Date: Jan. 10, 2013

(54) Optical Component Fabrication Using Coated Substrates

(75) Inventors: Joseph Paul Luc GIRARD, Benicia, CA (US); Louis Andrew Marchetti, Albany, CA (US); Robert N. Kestner, Concord, CA (US); James Kennon, Benicia, CA (US)

(73) Assignee: ASML Holding N.V., Veldhoven (NL)

(21) Appl. No.: 13/617,652

(22) Filed: Sep. 14, 2012

Related U.S. Application Data
(62) Division of application No. 12/119,112, filed on May 12, 2008.
Application No. 12/119,112 is a continuation-in-part of application No. 11/798,335, filed on May 11, 2007.

(51) Int. Cl. B05D 5/06

(52) U.S. Cl. 427/8

(57) ABSTRACT

A method of fabricating or preparing an optical component, such as a mirror, using an amorphous oxide coated substrate is presented. An amorphous oxide coating is applied to an optical substrate. An assessment of surface roughness of the coated surface is performed. The coated surface is polished based on the assessment. Initial assessments can be conducted and polishing can be performed based on those initial assessments prior to applying the coating to better prepare the surface for the coating. Each assessment can assess the surface's Mid-Spatial Frequency Roughness (MSFR), High-Spatial Frequency Roughness (HSFR), or both. The performing of the assessments, polishing and/or coating can be computer-controlled. This process is ideal in the fabrication of an optical component formed from a substrate with a near-zero coefficient of thermal expansion. An optical component fabricated in this manner is also presented.

### CROSS REFERENCE TO RELATED APPLICATIONS

This application is a divisional of U.S. Non-Provisional Application of Ser. No. 12/119,112 filed May 12, 2008, which is a continuation-in-part of U.S. application Ser. No. 11/798,335, filed May 11, 2007, which is incorporated by reference herein in its entirety.

### BACKGROUND

1. Field of the Invention

The present invention is directed generally to optic fabrication. More particularly, the present invention relates to the fabrication of optical components, such as mirrors, for use in lithographic processing.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a conventional apparatus, a patterning device, which can be referred to as a an array of individually controllable elements, a mask, a reticle, or the like, can be used to generate a circuit pattern corresponding to an individual layer of an IC, flat panel display, or other device. This pattern can be transferred onto all or part of the substrate (e.g., a glass plate, a wafer, etc.), by imaging onto a layer of radiation-sensitive material (e.g., resist) provided on the substrate. The imaging can include the processing of light through a projection system, which can include optical components such as mirrors, lenses, beam splitters, and the like.

The optical components used in lithographic processing can be fabricated out of a variety of materials. However, many materials are not currently chosen for manufacturing reasons or due to recent performance needs. Two materials currently used widely in the lithography industry are Zerodur® (produced by SCHOTT Corporation) and Ultra Low Expansion (ULE®) glass (produced by Corning Inc.). Additional optical substrate materials that may be employed are: cordierite, clearceram, neoceram, astrosital, SiC and SiSiC. Most of these materials exhibits a near-zero coefficient of thermal expansion (CTE). An optical component made of either of these materials will not change shape appreciably during exposure, which is of particular importance for certain types of lithographic processing, such as extreme ultra-violet (EUV) processing.

A cause of image flare is Mid-Spatial Frequency Roughness (MSFR), i.e., periodic surface errors found in optical components, which can scatter light near the intended image. In projection systems, EUV projection systems in particular, it is desirable to reduce image flare as much as possible. This is mainly to reduce the image flare's impact on contrast. Another level of spatial frequency roughness in optical components, known as High-Spatial Frequency Roughness (HSFR), can impact transmission by scattering light outside of the image field. Having MSFR and/or HSFR that are too high can cause clarity, resolution, and background light issues, among many other problems. It is ideal to have MSFR and HSFR be as low as possible for each optical component. The ranges of MSFR and HSFR for a particular optical component are dependent on the component size. Therefore, what is considered MSFR and HSFR will vary among the optical components of a particular system. Currently, MSFR is typically on the order of millimeters (mm) to micrometers (μm) and HSFR is typically on the order of micrometers (μm) to nanometers (nm).

Although both Zerodur® and ULE® glass exhibit otherwise ideal properties for lithographic (particularly, EUV) processing, they each have intrinsic material properties that make achieving the desired MSFR and HSFR extremely challenging. For example, Zerodur® is a multiphase material. Some optics manufacturing processes, such as ion beam figuring (IBF), affect phases at different rates, which essentially limits the achievable MSFR/HSFR. ULE® glass is a multilayer material. Some optics manufacturing processes work differently on the layers, causing striae, thereby creating another challenge for meeting the desired MSFR/HSFR specification(s).

Currently in industry, thin film coatings are sometimes applied to polished optical surfaces for the purpose of creating a resultant smoother surface, in other words, reducing MSFR and/or HSFR. However, the methods currently used in industry do not guarantee that the necessary ranges of MSFR and/or HSFR are reached during fabrication.

Therefore, what is needed is a method for producing an optical component, and the optical component produced, exhibiting desired ranges of MSFR and HSFR, which are conducive to providing low scatter and low image flare when used during lithographic processing.

### BRIEF SUMMARY

In one embodiment of the present invention, a method of fabricating or preparing an optical component, such as a mirror, using an amorphous oxide coated substrate is presented. An amorphous oxide coating, such as SiO₂ or SiO, for example, is applied to an optical substrate. An assessment of surface roughness of the coated surface is performed. The coated surface is then polished based on the assessment. Initial assessments can be conducted and polishing can be performed based on those initial assessments prior to applying the coating in order to better prepare the surface for the coating. Each of the assessments can assess the surface's Mid-Spatial Frequency Roughness (MSFR), High-Spatial Frequency Roughness (HSFR), or both. An initial polish of the surface can be conducted first to provide aspherization, for example. The performing of the assessments, polishing and/or the coating can be computer-controlled. An optical component fabricated in this manner is also presented.

This process is ideal in the fabrication of an optical component (a mirror, in particular) that is formed from a substrate with a near-zero coefficient of thermal expansion. Such a substrate can be made of a multiphase material, such as Zerodur® (a glass ceramic) or of a multilayer material, such as Ultra Low Expansion (ULE®) glass, for example.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a simplified block diagram of an exemplary lithographic apparatus.

FIG. 2 is a simplified block diagram of an exemplary optical component fabrication system.

FIG. 3 is a flowchart of an example method of optical component fabrication.

FIG. 4 is a flowchart depicting a method of optical component fabrication, according to an embodiment of the present invention.

FIG. 5 is a block diagram of an optical component fabrication system, according to an embodiment of the present invention.

FIG. 6 depicts an optical component, according to an embodiment of the present invention.

FIG. 7 is a flowchart of a method of preparing an optical component for use in lithographic processing, according to an embodiment of the present invention.

FIG. 8 is a flowchart of a method of fabricating an optical component for use in lithographic processing, according to an embodiment of the present invention.

FIG. 9 is a power spectral density (PSD) plot showing the roughness of a bare Zerodur® substrate, the roughness of a SiO₂ coated sample with no subsequent polishing, and achieved results to date on a Zerodur® sample prepared according to an embodiment of the present invention.

The present invention will be described with reference to the accompanying drawings. The drawing in which an element first appears is typically indicated by the leftmost digit(s) in the corresponding reference number.

### DETAILED DESCRIPTION OF THE INVENTION

While specific configurations, arrangements, and steps are discussed, it should be understood that this is done for illustrative purposes only. A person skilled in the pertinent art will recognize that other configurations, arrangements, and steps can be used without departing from the spirit and scope of the present invention. It will be apparent to a person skilled in the pertinent art that this invention can also be employed in a variety of other applications.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to incorporate such a feature, structure, or characteristic in connection with other embodiments whether or not explicitly described.

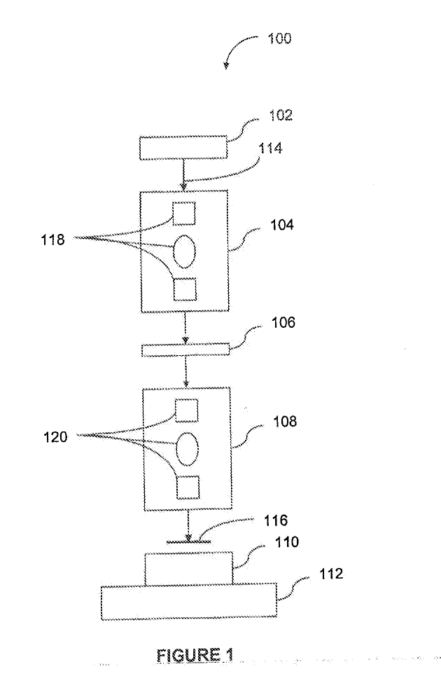

FIG. 1 is a simplified block diagram shown as an example lithographic apparatus 100. Lithographic apparatus 100 includes a radiation source 102, an illumination system 104, a patterning device 106 (e.g., a mask or maskless patterning device), a projection system 108, a substrate table 110, and a substrate stage 112. Radiation source 102 provides a light beam 114 that is processed by illumination system 104, patterning device 106, and projection system 108, such that an image is produced on a substrate 116 on substrate table 110. Illumination system 104 can include one or more optical components 118, for example, that condition light beam 114 prior to passing through patterning device 106. Similarly, projection system 108 can include one or more optical components 120 that further condition light beam 114 prior to projecting the image onto substrate 116. The optical components 106/118/120 can include, but are not to be limited to, lenses, mirrors, patterning devices, and beam splitters, for example.

The optical components 106/118/120 are commonly made from a variety of materials with a non-amorphous structure, and of those, silicon carbide and beryllium are typical. However, it is desirable that the optical components used are of a material having a near-zero coefficient of thermal expansion so as not to appreciably change shape during exposure (e.g., when light beam 114 is illuminated). Examples of materials having a near-zero coefficient of thermal expansion include Zerodur®, ULE® glass, cordierite, clearceram, neoceram, and astrosital, as discussed above. Other optical materials such as SiC and SiSiC may also be used and can, therefore, benefit from the invention.

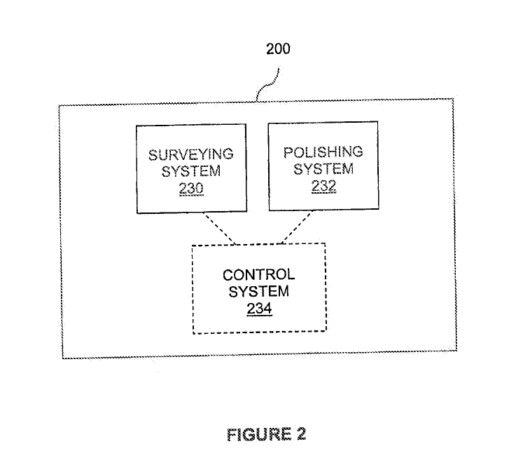

A simplified block diagram of a conventional manufacturing system 200 for fabricating an optical component 106/118/120 is shown in FIG. 2. Manufacturing system 200 includes a surveying system 230, a polishing system 232, and an optional control system 234. Surveying system 230 surveys or assesses the topography of a surface of an optical component. This can be done using a phase-measuring microscope, for example. Polishing system 232 polishes the surface. This polishing can be done based on the results of the assessment of surveying system 230. Optional control system 234 can be used to control and/or automate the use of surveying system 230 and/or polishing system 232.

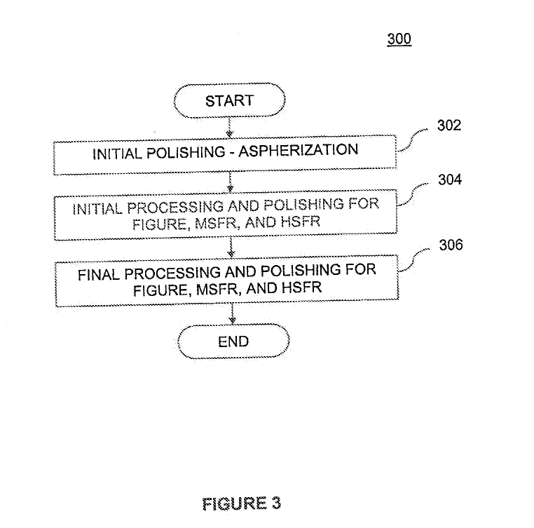

FIG. 3 depicts, via flowchart, an example method 300 of optical component fabrication, such as that conducted using manufacturing system 200. Conventional method 300 starts at step 302. In step 302, initial polishing of an optical substrate is conducted. The optical substrate can comprise any material typically used for an optical component. This initial polishing can include aspherization (i.e., applying a desired shape, making the surface non-spherical), for example, and can be conducted by polishing system 232. In step 304, initial processing and polishing for figure, MSFR, and HSFR occurs. The initial processing includes surveying or assessing the topography of a surface of the optical substrate for MSFR and/or HSFR. This assessment can be conducted by surveying system 230, for example. Based on the results of this assessment, the optical substrate is polished, for example by polishing system 232. In step 306, final processing and polishing for figure, MSFR, and HSFR is conducted. This final processing step includes surveying or assessing the topography of the surface of the optical substrate a final time, and can be conducted once again by surveying system 230. Differing parameters may be used for this assessment than used for the initial assessment in step 304. Based on the results of this final assessment, the optical substrate is polished to provide figure correction. This final polishing step can, again, be conducted by polishing system 232. The polishing of steps 302/304/306 can be conducted using differing parameters, for example based on the conducted assessments. The processing of steps 304/306 can include testing or measuring the optical substrate surface, for example with a phase-measuring microscope. In addition, any of the foregoing steps 302-306 of conventional method 300 can be optionally controlled and/or automated by control system 234.

Other methods are depicted in the following references: Spiller et al., “Smoothing of mirror substrates by thin-film deposition,” SPIE Conference on EUV, X-RAY, and Neutron Optics and Sources, Jul. 21, 1999, Denver, Colo., Proceedings of SPIE Vol. 3767, edited by Carolyn A. MacDonald, Kenneth A. Goldberg, Juan R. Maldonado, Huaiyu H. Chen-Mayer, and Stephen P. Vernon, November 1999, pp. 143-153; Braun et al., “Carbon buffer layers for smoothing substrates of EUV and X-ray multilayer mirrors,” SPIE Conference on Testing, Reliability, and Application of Micro- and Nano-Material Systems II, Mar. 15, 2004, San Diego, Calif., Proceedings of SPIE Vol. 5392, edited by Norbert Meyendorf, George Y. Baaklini, and Bernd Michel, SPIE, Bellingham, Wash., July 2004, pp. 132-140; and Kleineberg et al., “Bufferlayer and Caplayer Engineering of Mo/Si EUVL Multilayer Mirrors,” SPIE Conference on Soft X-Ray and EUV Imaging Systems II, Jul. 31, 2001, San Diego, Calif., Proceedings of SPIE Vol. 4306, edited by Daniel A. Tichenor and James A. Folta, December 2001, pp. 113-120, all of which are incorporated by reference herein in their entireties. See also U.S. Pat. Appl. Pub. No. 2003/0057178 A1, to Michael Goldstein, entitled “Method for Making a Mirror for Photolithography,” published on Mar. 27, 2003 and filed Sep. 26, 2001, and European Pat. Appl. No. EP 0 955 565 A2, to Murakami et al., entitled “Mirror for Soft X-Ray Exposure Apparatus,” published on Nov. 10, 1999, both of which are incorporated by reference herein in their entireties.

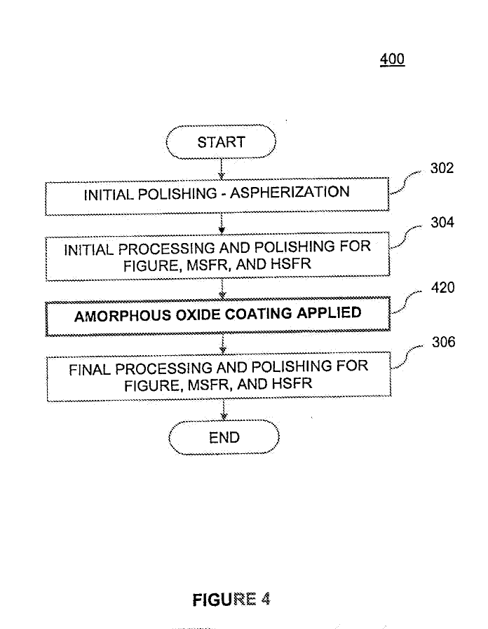

FIG. 4 shows a significant improvement to method 300 of FIG. 3, according to an embodiment of the present invention. Fabrication method 400 applies a coating of silicon or an amorphous oxide (such as a silicon oxide SiO or SiO₂ (fused silica)) in step 420 between initial processing and polishing step 304 and final processing and polishing step 306. In other words, the silicon or amorphous oxide coating is applied to an optical substrate that has been processed to an optimal pre-coating smoothness. The coating can be applied onto the polished surface in a number of conventional manners, such as but not limited to, physical vapor sputtering or coating, ion-assisted sputtering or coating, chemical-assisted coating or sputtering, or evaporation. The coating can be thin, but needs to be thick enough to allow for further polishing in step 306. Whereas the multiphase characteristic of Zerodur® and multilayer characteristic of ULE® glass will manifest themselves during certain polishing operations, the single-phase coating can be uniformly polished with most, if not all, polishing processes, which will result in a smoother optical surface.

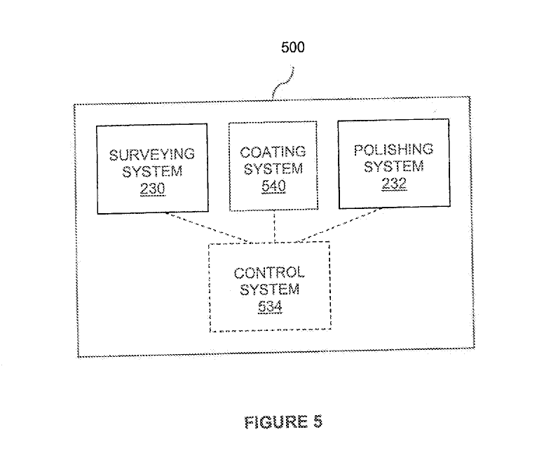

FIG. 5 depicts a simplified block diagram of a manufacturing system 500 for fabricating an optical component, such as optical component 106/118/120, according to an embodiment of the present invention. Manufacturing system 500 includes surveying system 230, polishing system 232, and optional control system 534, as well as a coating system 540 for applying the silicon or amorphous oxide coating discussed above. Optional control system 534 can be used to control and/or automate the use of surveying system 230, polishing system 232, and/or coating system 540.

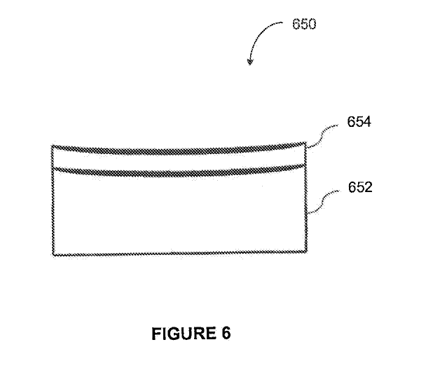

FIG. 6 depicts an optical component 650 (e.g., a mirror), according to an embodiment of the present invention. Optical component 650 includes an optical substrate 652, for example made of a material that has a near-zero coefficient of thermal expansion (such as Zerodur® or ULE® glass), that has been processed and polished. Optical component 650 also includes a layer 654 of silicon, as an example, SiO or SiO₂, or another amorphous oxide that has been assessed for its MSFR and/or HSFR and has been polished according to the method(s) of the present invention.

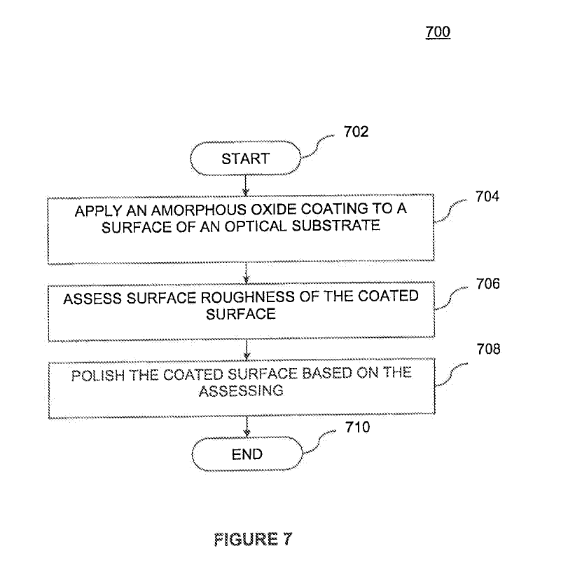

FIG. 7 is a flowchart of a method 700 of preparing an optical component, such as optical component 650, for use in lithographic processing, according to an embodiment of the present invention. Method 700 begins at step 702 and immediately proceeds to step 704. In step 704, a coating of an silicon, as an example, SiO or SiO₂, or another amorphous oxide (e.g., layer 654) is applied to a surface of an optical substrate (e.g., optical substrate 652). Prior to the application of the coating, the optical component can be prepared to an optimal pre-coating smoothness. In step 706, a post-coating survey or assessment of the coated surface is conducted to assess surface roughness. This post-coating assessment can include an assessment of MSFR, HSFR, or ideally both. According to the results of the post-coating assessment, the coated surface is polished in step 708. The polishing can be to the desired MSFR and/or HSFR for optimal performance of the component. Method 700 ends at step 710. The assessment step 706 can be conducted using a phase-measuring microscope, for example. Any of steps 704/706/708 can optionally be automated or computer-controlled.

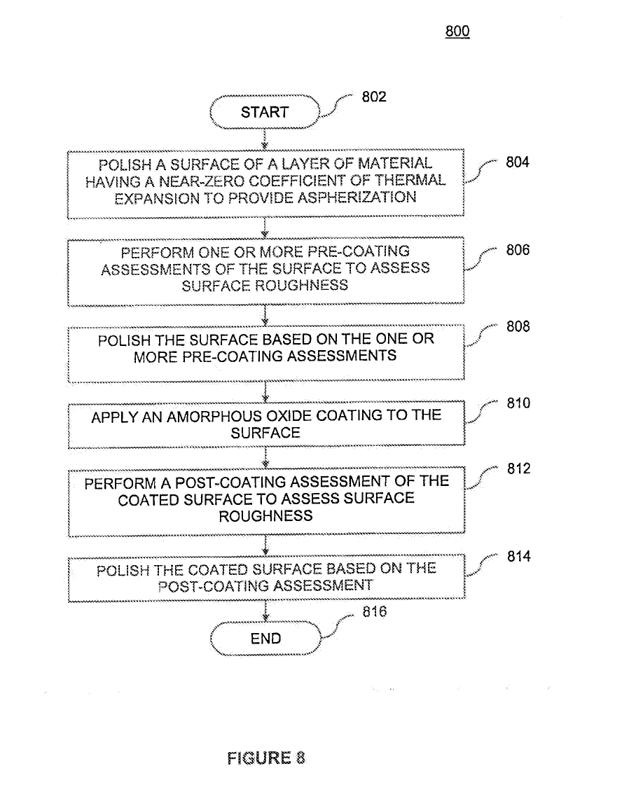

FIG. 8 is a flowchart of a method 800 of fabricating an optical component (e.g., optical component 650) for use in lithographic processing, according to an embodiment of the present invention. Method 800 begins at step 802 and immediately proceeds to step 804. In step 804, a surface of a layer of material formed as an optical component and having a near-zero coefficient of thermal expansion is initially polished. For example, Zerodur®, ULE® glass, cordierite, clearceram, neoceram, or astrosital can be used. This initial polish can provide aspherization, for example. In step 806, one or more pre-coating surveys or assessments of the surface are conducted to assess surface roughness. These pre-coating assessments can include assessments of MSFR, HSFR, or ideally both. According to the results of each pre-coating assessment, the surface is polished in step 808. The polishing can be to the desired MSFR and/or HSFR. The pre-coating steps 804/806/808 provide an optical substrate with an optimal pre-coating smoothness. In step 810, a coating of silicon, as an example, SiO or SiO₂, or another amorphous oxide is applied to the surface. In step 812, a post-coating survey or assessment of the coated surface is conducted to assess surface roughness. This post-coating assessment can include an assessment of MSFR, HSFR, or ideally both. According to the results of the post-coating assessment, the coated surface is polished in step 814. The polishing can be to the desired MSFR and/or HSFR for optimal performance of the component. Method 800 ends at step 816. Assessment steps 806/812 can be conducted using a phase-measuring microscope for example, and differing parameters can be used for each assessment. Likewise, differing parameters can be used for polishing steps 804/808/814, for example based on the assessments of assessment steps 806/812. Any of steps 804-814 can optionally be automated or computer-controlled.

The exemplary embodiments of the invention described herein facilitate the fabrication of optical components (in particular, mirrors) that are made from multiphase multilayer or porous materials such as Zerodur®, ULE® glass, cordierite, clearceram, ceoceram, astrosital, SiC and SiSiC respectively, which are extremely critical to the EUV processing due to their near-zero coefficients of thermal expansion. These embodiments are advantageous because the potential for reaching the desired MSFR (currently less than 0.14 nm rms for EUV applications) is possible with a substrate coated according to embodiments described herein, but is unlikely to be achieved with a bare substrate.

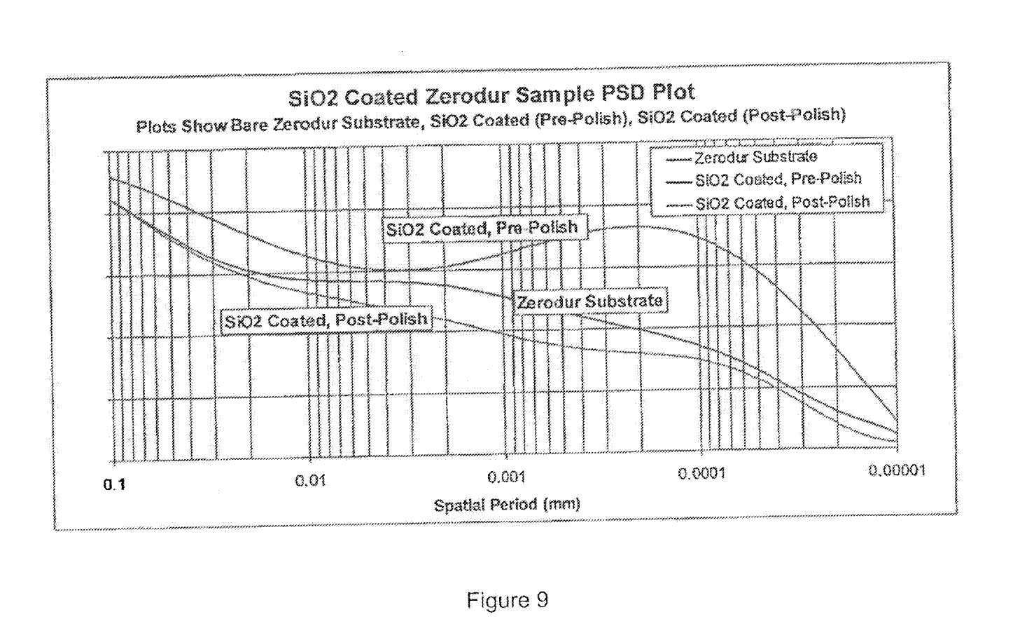

FIG. 9 is a power spectral density (PSD) plot showing the achieved results to date on a Zerodur® sample prepared according to an embodiment of the present invention. The ability to achieve the necessary smoothness in the spatial periods between 100 μm and 10 nm is demonstrated in the plot. The plot also shows the roughness of the bare Zerodur® sample before coating, and the roughness of the SiO₂ coated sample before polishing according to embodiments of the present invention.

Although specific reference is made in this text to a fabrication process for optical components used for lithographic processing, it should be understood that the fabrication process described herein can be used to fabricate optical components for use in any application in which optical components are used. Further, specific reference is made herein to EUV processing-related advantages of the invention. However, it should be understood that other processing techniques would benefit from the use of optical components fabricated according to embodiments of the present invention. These processing techniques include, but should not be limited to, ultra smooth optics and ultra precise optics, for example. In addition, although the optical materials Zerodur® and ULE® glass are highlighted as ideal materials to use for the optical component fabrication as described herein, other materials having low coefficients of thermal expansion may also be suitable, as would be understood by those of ordinary skill in the relevant art(s).

It is to be appreciated that these above-noted embodiments can be used in conventional mask-based lithography, maskless lithography, immersion lithography, interferometric lithography, or other types of optical systems that include a similar functioning optical system.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method, comprising:
(a) applying a coating to a surface of an optical substrate, the coating being a silicon based coating, an amorphous oxide coating, or a combination thereof;
(b) assessing surface roughness of the coated surface; and
(c) polishing the coated surface based on the assessing,
wherein the polished coated surface has a surface roughness conducive to providing low scatter and low image flare.

2. The method of claim 1, wherein step (a) comprises applying a silicon oxide coating.

3. The method of claim 1, wherein step (b) comprises assessing at least one of a Mid-Spatial Frequency Roughness (MSFR) or a High-Spatial Frequency Roughness (HSFR).

4. The method of claim 1, wherein, before step (a), the method further comprises:
initially polishing the surface to provide aspherization.

5. The method of claim 1, wherein, before step (a), the method further comprises:
performing one or more initial assessments of the surface to determine surface roughness; and
polishing the surface based on the one or more initial assessments.

6. The method of claim 5, wherein the performing the one or more initial assessments comprises, for each of the one or more initial assessments, assessing at least one of a MSFR or a HSFR.

7. The method of claim 1, wherein step (a) comprises applying the coating to a surface of a mirror blank.

8. The method of claim 1, wherein step (a) comprises applying the coating to an optical substrate that has a near-zero coefficient of thermal expansion.

9. The method of claim 8, wherein step (a) comprises applying the coating to an optical substrate made of a multiphase material.

10. The method of claim 1, wherein step (a) comprises applying the coating to an optical substrate made of Zerodur, Ultra Low Expansion (ULE®) glass, cordierite, clearceram, neoceram, astrosital, SiC, or SiSiC.

11. The method of claim 8, wherein step (a) comprises applying the coating to an optical substrate made of a multilayer material.

12. The method of claim 1, wherein one or more of steps (a), (b), or (c) are computer-controlled.

13. A method, comprising:
(a) polishing a surface of an optical substrate to provide aspherization;
(b) performing one or more pre-coating assessments of the surface to assess surface roughness;
(c) polishing the surface based on the one or more pre-coating assessments;
(d) applying a coating to the surface, the coating being a silicon based coating, an amorphous oxide coating, or a combination thereof;
(e) performing a post-coating assessment of the coated surface to assess surface roughness; and
(f) polishing the coated surface based on the post-coating assessment,
wherein the polished coated surface has a surface roughness conducive to providing low scatter and low image flare.

14. The method of claim 13, wherein step (d) comprises applying a silicon oxide coating to the surface.

15. The method of claim 13, wherein steps (b) and (e) comprise, for each assessment, assessing at least of a MSFR or a HSFR.

16. The method of claim 13, wherein step (a) comprises polishing a surface of a mirror blank.

17. The method of claim 13, wherein step (a) comprises polishing a surface of a near-zero coefficient of thermal expansion mirror blank.

18. The method of claim 17, wherein step (a) comprises polishing a surface of an optical substrate made of a multiphase material.

19. The method of claims 13, wherein step (a) comprises polishing a surface of an optical substrate made of a material Zerodur®, Ultra Low Expansion (ULE®) glass, cordierite, clearceram, neoceram, astrosital, SiC, or SiSiC.

20. The method of claim 13, wherein step (a) comprises polishing a surface of an optical substrate made of Zerodur®.

21. The method of claim 13, wherein one or more of steps (a) to (f) are computer-controlled.
